(19) United States
(12) Patent Application Publication
(10) Pub. No.: US 2019/0360253 A1
(43) Pub. Date: Nov. 28, 2019

(54) DOOR CLOSER SYSTEM

(71) Applicant: D. Savi Prashad, Maspeth, NY (US)

(72) Inventor: D. Savi Prashad, Maspeth, NY (US)

(21) Appl. No.: 16/419,857

(22) Filed: May 22, 2019

Related U.S. Application Data
(60) Provisional application No. 62/674,733, filed on May 22, 2018.

(51) Int. Cl. E05F 3/22; E05F 3/16; E05F 1/10

(52) U.S. Cl. CPC E05F 3/224; E05F 3/16; E05F 1/10; E05Y 2201/70; E05Y 2900/132; E05Y 2800/113; E05Y 2201/21

(57) ABSTRACT

A door closer system that comprises a left post, a right post, a top frame and a bottom fame all connected to each other, wherein the left post, the right post, the top frame and the bottom frame are configured to hold a door, wherein the bottom frame includes a first adjustable multi-sizing spring force and a second adjustable multi-sizing spring fore, where the first adjustable multi-sizing spring force and the second adjustable multi-sizing spring force are configured to allow control of the door, where the door may have a plurality of weights and sizes. The bottom frame includes a custom hinge with a special closer, wherein the special closer is configured to pivot to swing into a bearing at the top frame and the bottom frame to allow free and easy ADA movement. The special closer includes a check valve allowing the door to return to a center closed position.

### CROSS REFERENCE TO RELATED APPLICATION

This non-provisional patent application claims priority to a U.S. Provisional Patent Application No. 62/674,733 filed on May 22, 2019 which is incorporated herein by reference.

### FIELD OF THE INVENTION

The present invention relates to a door closer system.

### BACKGROUND OF THE INVENTION

Typically, door closer systems are used to allow people to be transferred from one area to another. Though some door closer systems work efficiently they don't always comply with American with Disability Act (ADA) requirements and are not able to handle doors that are sizable in weight. Thus, there is a need for a door closer system that complies with ADA requirements that can simply handle doors with a sizable weight.

### SUMMARY OF THE INVENTION

The present invention has been accomplished in view of the above-mentioned technical background, and it is an object of the present invention to provide a door closer system.

A door closer system that comprises a left post, a right post, a top frame and a bottom frame all connected to each other, wherein the left post, the right post, the top frame and the bottom frame are configured to hold a door, wherein the bottom frame includes a first adjustable multi-sizing spring force and a second adjustable multi-sizing spring force, where the first adjustable multi-sizing spring force and the second adjustable multi-sizing spring force are configured to allow control of the door, where the door may have a plurality of weights and sizes. The bottom frame includes a custom hinge with a special closer, wherein the special closer is configured to pivot to swing into a bearing at the top frame and the bottom frame to allow free and easy ADA movement. The special closer includes a check valve allowing the door to return to a center closed position.

### BRIEF DESCRIPTION OF THE DRAWINGS

These and other advantages of the present invention will become more apparent as the following description is read in conjunction with the accompanying drawings, wherein:

FIG. 1 is a schematic representation of a side view of a door closer system

FIG. 2 is a schematic representation of a top view of the door closer system of FIG. 1;

FIG. 3 is a front view of the schematic representation of the door closer system of FIG. 1;

FIG. 4 is a focused side view of the schematic representation of the door closer system of FIG. 1;

FIG. 5 is a schematic representation of a side view of another door closer system;

FIG. 6 is a schematic representation of a top view of the door closer system of FIG. 5;

FIG. 7 is a front view of the schematic representation of the door closer system of FIG. 5; and

FIG. 8 is a focused side view of the schematic representation of the door closer system of FIG. 5.

### DETAILED DESCRIPTION OF THE INVENTION

The presently preferred embodiments of the invention are described with reference to the drawings, where like components are identified with the same numerals. The descriptions of the preferred embodiments are exemplary and are not intended to limit the scope of the invention.

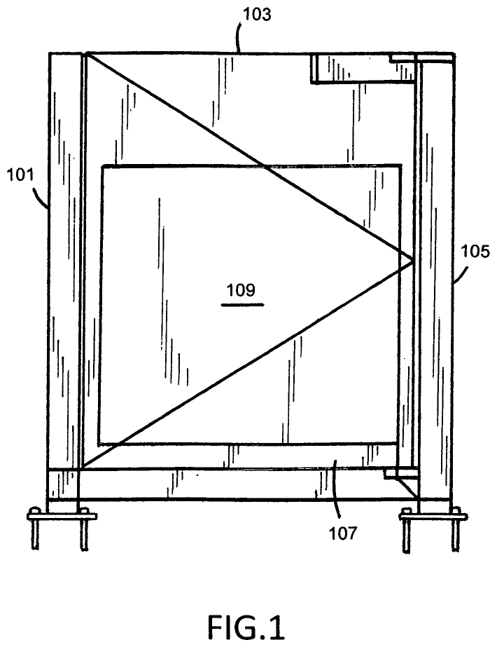

FIG. 1. is a schematic representation of a side view of a door closer system. The door closer system 100 shows the left post 101, top frame 103, right post 105, bottom frame 107 and door 109. Left post 101 and right post 105 are fully ADA compliant and features strengthened HSS 4″×4″×¼″ Posts.

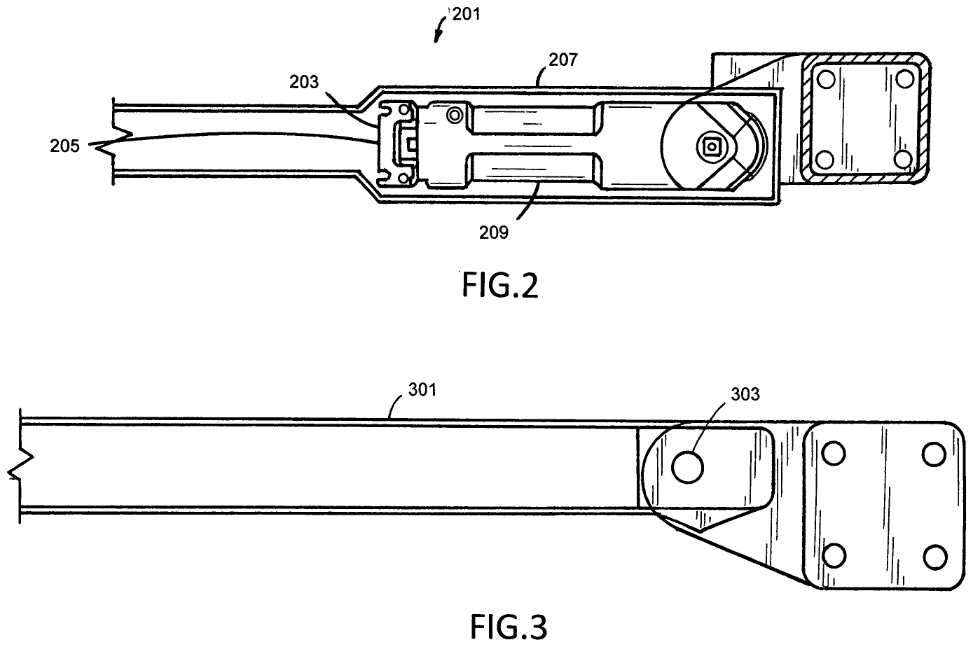

FIG. 2 shows a top view of the door closer system. The top view shows a top portion 201 of the left post 101. Top portion 201 includes spring 203, speed control valve 205, center adjustment gears 207 and 209. Spring 203 is an adjustable multi-sizing spring that has a force range of 1 through 6 to allow control of a wide range of door weights up to 1,000 pounds. The custom made closer features adjustable spring power 203 that allows it to be set to comply with ADA specified opening forces. The speed control valve 205 along with the special closer 401 is manufactured to allow smooth closing speed of approximately 5 to 7 seconds from a 90-degree position.

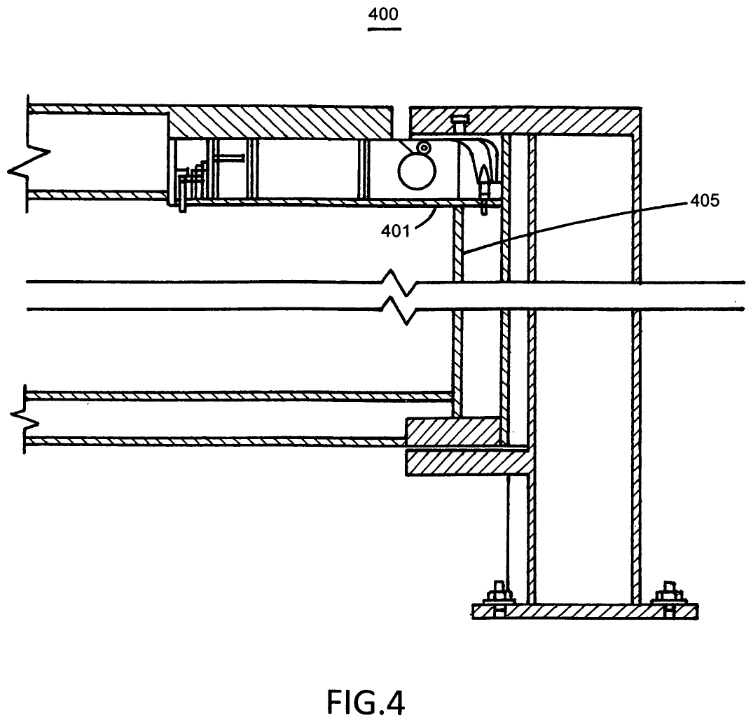

FIG. 3 shows a bottom view of the door closer system. Bottom frame 107 includes a bottom portion 301. Bottom portion 301 includes custom hinge 303. Custom hinge 303 works in conjunction with custom made door closer or special closer 401 (FIG. 4) that is pivoted to swing approximately 120 degrees into a self-lubricating bearing at the top frame 103 and the bottom frame 107.

FIG. 4 shows a close in view of the custom-made door closer system 400. Custom made door closer system 400 includes a special closer 401 designed for use on larger, heavier doors weighing up to 1,000 pounds. This door closer 401 includes a custom hinge 303 designed to work in conjunction with the special closer 401 that is pivoted to swing into a self-lubricating bearing at the top frame 103 (FIG. 1) and bottom frame 107 to allow free and easy ADA movement. The closer 401 is manufactured with a check valve 403 that allows the door 109 (FIG. 1) to return to the center closed position. The door 109 may have a tamper proof cover plate to keep dust and other objects away.

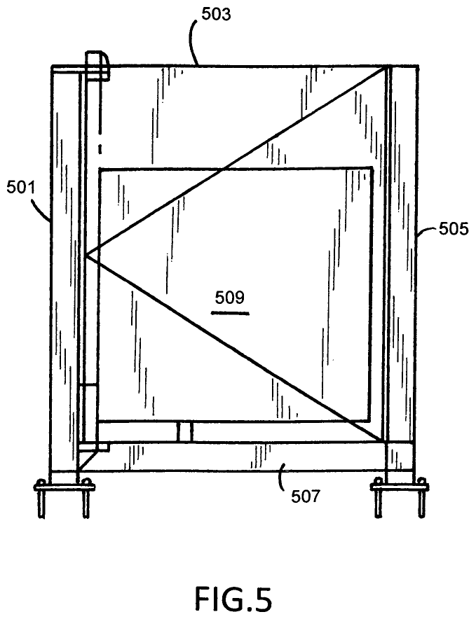

FIG. 5. is a schematic representation of a side view of a door closer system. The door closer system 500 shows the left post 501, top frame 503, right post 505, bottom frame 507 and a door 509. Left post 501 and right post 505 are fully ADA compliant and features strengthened HSS 4″×4″×¼″ Posts.

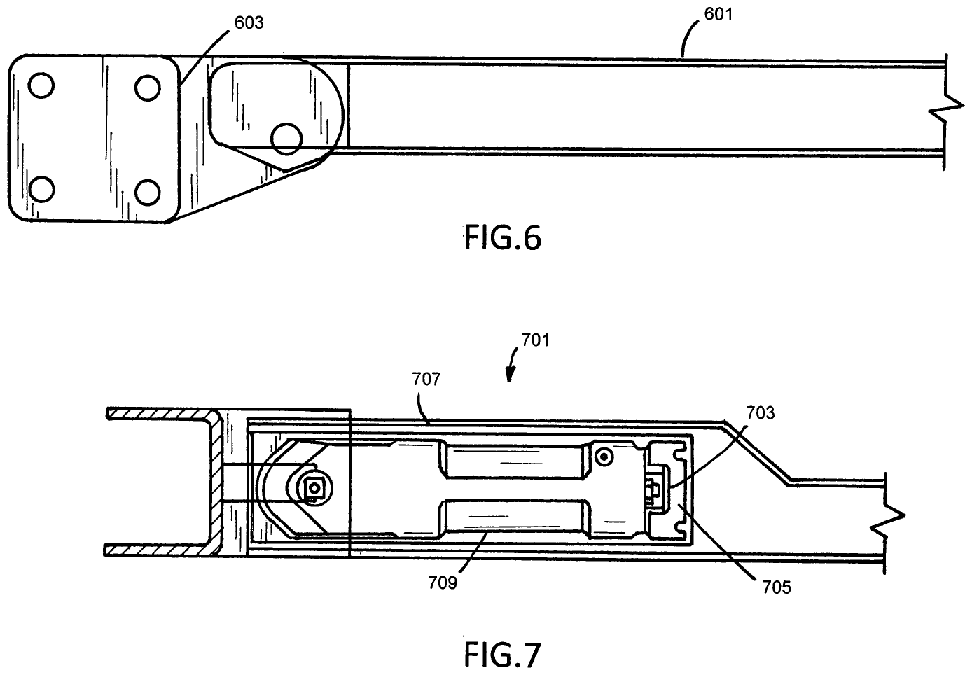

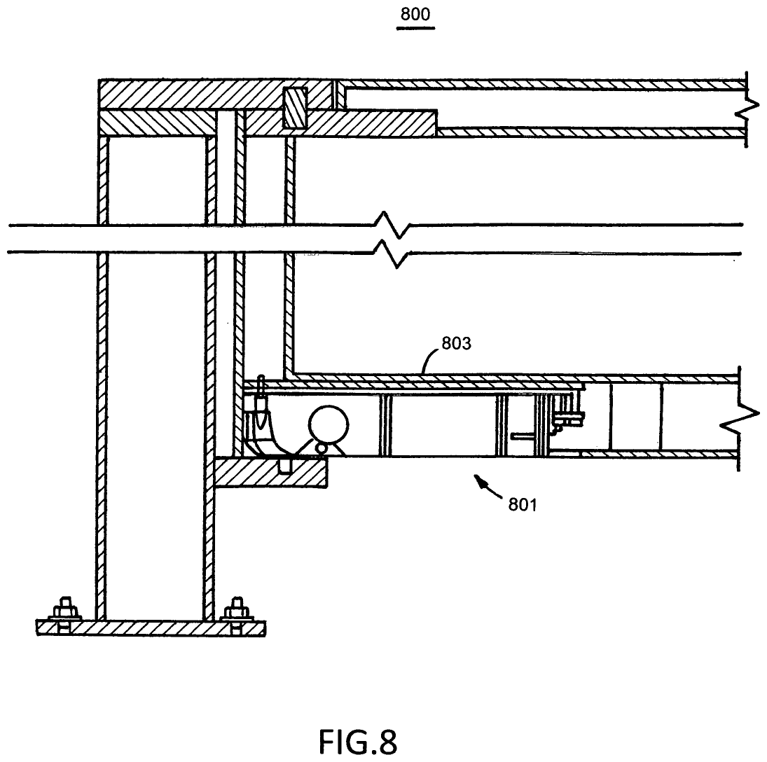

FIG. 6 shows a top view of the door closer system. The top view shows a top portion 601 of the left post 501. Top portion 601 includes custom hinge 603. Custom hinge 601 works in conjunction with custom made door closer or special closer 801 (FIG. 8) that is pivoted to swing approximately 120 degrees into a self-lubricating bearing at the top frame 503 (FIG. 5) and the bottom frame 507.

FIG. 7 shows a bottom view of the door closer system. Bottom portion 701 includes spring 703, speed control valve 705, center adjustment gear 707 and center adjustment gear 709. Spring 703 is an adjustable multi-sizing spring that has a force range of 1 through 6 to allow control of a wide range of door weights up to 1,000 pounds. The custom made closer features adjustable spring power 703 that allows it to be set to comply with ADA specified opening forces. The speed control valve 705 along with the special closer 801 (FIG. 8) is manufactured to allow smooth closing speed of approximately 5 to 7 seconds from a 90-degree position.

FIG. 8 shows a close in view of the custom made door closer system. Custom made door closer system 800 includes a special closer 801 is designed for use on larger, heavier doors weighing up to 1,000 pounds. The door closer 801 includes a custom hinge 603 (FIG. 6) designed to work in conjunction with the special closer 801 that is pivoted to swing approximately 120 degrees into a self-lubricating bearing at the top frame 503 (FIG. 5) and bottom frame 507 to allow free and easy ADA movement. The closer 801 is manufactured with a check valve 803 that allows the door 109 to return to the center closed position. The door 509 may have a tamper proof cover plate to keep dust and other objects away. The tamper proof cover plate is heath strengthened and is of low iron consistency.

This invention provides a simple method of making a door closer system that complies with American with Disability Acts (ADA) requirements for opening forces. This door closer system is designed for use on larger, heavier doors up to 1,000 pounds. Also, this door closer system includes an adjustable multi-sizing spring force range of 1 through 6 to control the door no matter the weight of the door. In addition, this door system includes a custom hinge to work in conjunction with a special closer that has a check valve that allows the door to return to the center closed position, where the centering adjusting gears are on either side.

What is claimed is:

1. A door closer system comprising:
a left post, a right post, a top frame and a bottom frame all connected to each other, wherein the left post, the right post, the top frame and the bottom frame are configured to hold a door, wherein the bottom frame includes a first adjustable multi-sizing spring force and a second adjustable multi-sizing spring force, wherein the first adjustable multi-sizing spring force and the second adjustable multi-sizing spring force are configured to allow control of the door, wherein the door may have a plurality of weights and sizes;
the bottom frame includes a custom hinge with a special closer, wherein the special closer is configured to pivot to swing into a bearing at the top frame and the bottom frame to allow free and easy ADA movement; and
the special closer includes a check valve allowing the door to return to a center closed position.

2. The system of claim 1 wherein the adjustable multi-sizing spring force has a force range of 1 through 6.

3. The system of claim 1 wherein the bottom frame includes centering adjustment gears.

4. They system of claim 1 wherein the special closer includes a speed control nut.

5. The system of claim 4, wherein the speed control nut has a closing speed of approximately 5 to 7 seconds.

6. They system of claim 5, wherein the closing speed of approximately 5 to 7 seconds is from a 90 degree open position.

7. The system of claim 1 wherein the door weighs in a range of to 1000 pounds.

8. The system of claim 1 wherein the bearing at the top frame and the bottom frame are self-lubricating.

9. A door closer system comprising:
a left post, a right post, a top frame and a bottom frame all connected to each other, wherein the left post, the right post, the top frame and the bottom frame are configured to hold a door, wherein the bottom frame includes a first adjustable multi-sizing spring force and a second adjustable multi-sizing spring force, wherein the first adjustable multi-sizing spring force and the second adjustable multi-sizing spring force are configured to allow control of the door, wherein the door may have a plurality of weights and sizes;
the top frame includes a custom hinge with a special closer, wherein the special closer is configured to pivot to swing into a bearing at the top frame and the bottom frame to allow free and easy ADA movement; and
the special closer includes a check valve allowing the door to return to a center closed position.
